(19) United States
(12) Patent Application Publication
(10) Pub. No.: US 2016/0300278 A1
(43) Pub. Date: Oct. 13, 2016

(54) Systems and methods for providing goods to customers at no direct monetary cost to the customers

(71) Applicant: Trevor John Totten, Westfield, IN (US)

(72) Inventor: Trevor John Totten, Westfield, IN (US)

(21) Appl. No.: 15/076,727

(22) Filed: Mar. 22, 2016

Related U.S. Application Data
(60) Provisional application No. 62/144,506, filed on Apr. 8, 2015.

(51) Int. Cl. G06Q 30/06; G06Q 30/02

(52) U.S. Cl. CPC G06Q 30/0601; G06Q 30/0253; G06Q 30/0282

(57) ABSTRACT

A method for providing goods to customers at no direct monetary cost to the customers is disclosed. The method aggregates good offers from suppliers and displays the offers for customer selection. Product selection sends a signal to the supplier to deliver the good to the customer. Utilization of the method is intended to result in a profitable situation for all three primary parties involved, comprising the supplier, the customer, and the user of the novel technology, thus creating value.

### RELATED APPLICATIONS

Provisional Utility Patent Application No. 62/144,506

### BACKGROUND OF THE INVENTION

The novel technology relates generally to the offer and exchange of goods. It relates more specifically to systems and methods for offering products for free on a network such as the Internet, where a plurality of products are provided by one or more suppliers for distribution to one or more customers.

The novel technology could be applied to any arrangement in which a collection of goods are aggregated and offered at no monetary cost to consumers, such that there is an opportunity cost of selecting one good over the others. For example, an Internet website could be used to display consumable products offered by brands and retailers, and the website could allow consumers to select a product at the opportunity cost of selecting another product that is offered simultaneously.

Businesses have historically employed a plurality of variations of profitable methods that involve distributing goods at no direct monetary cost to the customer in order to leverage the appeal of a free good in a way that is advantageous to the business. It is desirable to utilize a method that reduces or avoids the drawbacks associated with some of these methods.

One example is how shaving razor companies have offered shaving razors to a consumer at no monetary cost with the assumption that the consumer will pay a high price for razor blade replacements. Similarly, telecommunications companies have offered cellular telephones to a consumer at no monetary cost with the assumption that the consumer will pay a high price for the associated telephone service plan. In other words, the primary free product has little value without the expensive secondary counterpart. The novel technology favorably differs from this method because the value of the primary good that is offered typically does not rely on a secondary counterpart that is provided by the user of the novel technology.

Another example is how social media companies have offered free social media services such as data storage space, information on individuals and organizations, and networking opportunities to a consumer in exchange for the consumer's private personal information, which in some cases is then used for advertising purposes. The novel technology favorably differs from this method because it typically does not require the customer to disclose private personal information.

Another example is how companies across a variety of industries have offered a free product to a consumer in exchange for detailed feedback on the product, typically in the form of a survey. The novel technology favorably differs from this method because it typically does not require the customer to provide feedback.

Another example is how data sharing companies have offered free movies, music, and other software to a consumer illegally. The novel technology favorably differs from this method because it can operate lawfully.

### SUMMARY OF THE INVENTION

The novel technology is a method for providing goods to customers at no direct monetary cost to the customers. It aggregates product offers from suppliers and displays the offers for customer selection. Product selection sends a signal to the supplier to deliver the good to the customer. The novel technology is intended to result in a profitable situation for all three primary parties involved, comprising the supplier, the customer, and the user of the novel technology, thus creating value.

The novel technology is an improvement to the method of distributing free samples of a good to an unfocused, untargeted, random, or nearly random group of potential customers. This advantage is primarily achieved by leveraging the aspect of opportunity cost.

The novel technology is an improvement to the method of exchanging a free sample of a good primarily for sensitive information, such as private personal data.

The novel technology is an improvement to the method of exchanging a free sample of a good primarily for feedback, such as a subjective opinion about a good.

These and other aspects, features, and advantages of the novel technology are illustrated in the attached drawings and described in greater detail below.

### DESCRIPTION OF THE DRAWINGS

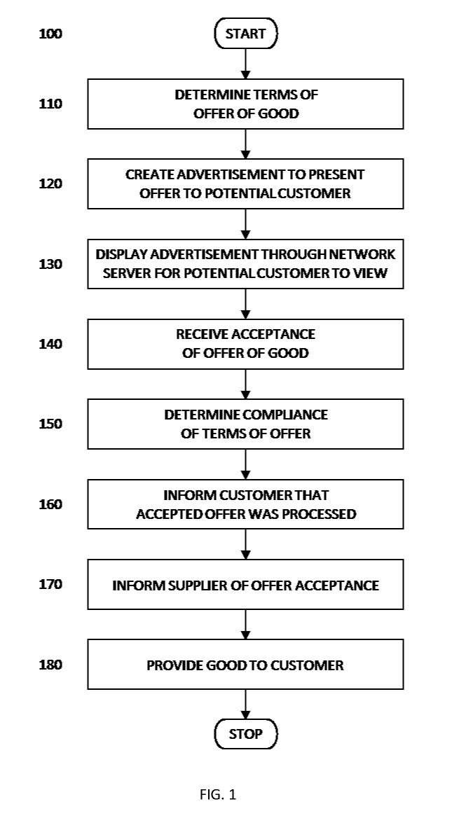

The preferred embodiments of the novel technology described in conjunction with the appended drawings are provided to illustrate and not to limit the novel technology, where like designations denote like elements, and in which FIG. 1 illustrates the process of the method as a process flow chart in accordance with one embodiment of the novel technology.

### DETAILED DESCRIPTION OF THE PREFERRED EMBODIMENT OF THE INVENTION

The following is a detailed description of representative embodiments to illustrate the principles of the novel technology. The embodiments are provided to illustrate aspects of the novel technology, but the novel technology is not limited to any embodiment. The scope of the novel technology encompasses numerous alternatives, modifications and equivalents; it is limited only by the claims. Numerous specific details are set forth in the following description in order to provide a thorough understanding of the novel technology. However, the novel technology may be practiced according to the claims without some or all of these specific details. For the purpose of clarity, technical material that is known in the technical fields related to the novel technology has not been described in detail so that the novel technology is not unnecessarily obscured.

The novel technology is a method for providing goods to customers at no direct monetary cost to the customers in a way that is intended to be profitable to the supplier, the customer, and the user of the novel technology.

The process of the system or method 100 is illustrated in FIG. 1 as a process flow chart in accordance with one embodiment of the novel technology.

The system or method 100 aggregates a plurality of offers of goods from one or more suppliers and determines the terms of each offer at step 110. The offer from the supplier to the customer is a product at no direct monetary cost. The terms of the offer may establish controls to be applied to the offer, and consequently to the distribution of goods, by imposing constraints on the customer's selection options. The constraints may be based on a number of factors comprising time, quantity, geographical location of the customer and supplier, selection history of the customer, good, and other goods offered by the supplier and competing suppliers, and availability of goods offered by the supplier and competing suppliers. For example, a selection cooldown system may be used. This cooldown system could control the rate at which products are available to specific customers. The system could utilize any pattern or random arrangement of product availability sequences. Perhaps the system is designed such that a particular product is available to every customer only on Mondays, Wednesdays, and Fridays. Or perhaps the product's availability is adjusted based on the number of times a specific customer selects the product. For example, the system could initiate a cooldown timer for a particular product that doubles each time a customer selects it. If a customer were to select the product for the first time, the cooldown timer could be set at 24 hours. After 24 hours, the product could become available to the customer once again. Upon a second selection of the same product by the same customer, the cooldown timer could be set at 48 hours. This algorithm for product distribution control could be continuous as a means to preserve the benefits of the novel technology, such as distribution of a product sample to a large and diverse population, feedback from a large and diverse population, and a higher probability that a customer will purchase a product rather than wait for the active cooldown timer to end. The offer control system is one aspect of how the novel technology is able to potentially distribute free products indefinitely while still being profitable.

The system or method 100 creates an advertisement for the offer of the good to present to the potential customer at step 120.

The system or method 100 displays the advertisement for the offer through a network server for potential customers to view at step 130. For example, the offers could be displayed on an Internet website. The website could show the name, description, supplier, and picture of each good in a way that clearly identifies the product to the potential customers viewing the website so that selection is easy.

The system or method 100 receives a customer's acceptance of an offer at step 140. For example, the acceptance could be in the form of an electronic signal that was triggered by a button click on an Internet website.

The system or method 100 determines whether a customer's acceptance of an offer is in compliance with the terms of the offer at step 150.

The system or method 100 informs the customer that accepted an offer that the accepted offer was processed at step 160. For example, an email message with confirmation details may be sent to the customer following validation of the acceptance.

The system or method 100 informs the supplier of a good after the good is selected by a customer at step 170. For example, an automatic email system could be designed to send an email message to the supplier after a customer confirms the selection of a product from the supplier by clicking a button on an Internet website and the selection is validated.

The system or method 100 provides the good selected by a customer to the customer at step 180. For example, a distribution system may be designed such that the good is shipped directly to the customer from the supplier.

The system or method 100 may accept feedback on a good from a customer. For example, a customer may be able to follow a link on a website that accepts written commentary about an experimental product recently released to market by a particular supplier. The written commentary may then be delivered to the supplier of the product to help improve the product.

The system or method 100 is intended to result in a profitable situation for all three primary parties involved, comprising the supplier, the customer, and the user of the novel technology, thus creating value. The supplier may profit from the advertisement of its good, the probability that the customer will be addicted or in some other way continue to seek the good, the collection of feedback on its good, the statistical data collected on customer interest of its good, the statistical data collected on customer interest of its competitors' good, the customer's contact information, the improvement of its reputation, the amplification of its presence in the market, and the high customer conversion rate produced by the novel technology. The customer may profit from receiving a good at no direct monetary cost. The user of the novel technology may profit from the fees that the user charges to the suppliers in exchange for participating in the novel technology, and from advertisements placed around the display of goods.

The system or method 100 is an improvement to the method of distributing free samples of a good to an unfocused, untargeted, random, or nearly random group of potential customers. The novel technology achieves a customer conversion rate that is significantly higher than that of the latter method by leveraging opportunity cost to effectively filter out uninterested customers from a pool of potential customers. The novel technology is designed such that it is typically to the benefit of the genuinely interested customer, as opposed to the uninterested customer, to select a particular good offered by a particular supplier. The customer selects the good from a pool of other goods and the opportunity cost attached to the selection naturally encourages the customer to select the good of most interest at the time. It is to the benefit of the uninterested customer not to select the product because the pool of other goods is likely to contain a good of greater interest. For example, a customer who is an enthusiast of energy drinks and who has distaste for body lotions would not likely select a body lotion from the pool of available products when there is a new energy drink available in the pool that the customer may like, just for the sake of acting unpredictably. The customer would select the energy drink because that would be in the customer's best interest.

The system or method 100 is an improvement to the method of exchanging a free sample of a good primarily for sensitive information, such as private personal data. The novel technology is intended to avoid the ethical and legal contentiousness that exist in the latter method. For example, there is a risk that by sharing sensitive information, a business may break a law designed to protect the privacy of an individual. Additionally, storing and using sensitive information imposes constraints on the business managing it.

The system or method 100 is an improvement to the method of exchanging a free sample of a good for feedback, such as a subjective opinion about a good. The novel technology does not require the feedback to create value, while the latter method relies on it. For example, a free bag of potato chips may be offered by a global potato chip company in exchange for feedback on their existing products. The company would then plan to use the valuable feedback obtained from a diverse population of potential customers to improve their existing products or to release a new flavor of potato chips based on the customer interest data collected in the survey.

The system or method 100 provides a way to determine the maximum value of a product that a supplier is willing to give away in exchange for no direct monetary payment from a customer. For example, the novel technology at one time may be displaying a quantity of 1,000 different products from a plurality of suppliers across a plurality of product industries that cost the suppliers between $4 and $6 each to deliver to interested customers. Then, at a later time, a supplier may decide that the advantages that the novel technology offers to the supplier are significant enough to allow the supplier to offer a product of higher value that will cost the supplier $7 to deliver to an interested customer. By offering a product of higher value, the supplier sensibly expects that customers will likely prefer and select the product over other product options. As suppliers continue to offer products of higher value to compete with one another, the average cost and standard deviation of cost may tend to settle to values that make participating in the novel technology method just barely viable, similar to how a free market economy drives the price of a product down to a value that gives the supplier of the product just enough profit margin to make supplying the product profitable from a business perspective.

The system or method 100 provides a way to entice a consumer to share the consumer's contact information with the user of the novel technology or with a product's supplier. For example, the offer could explicitly state that a free product will be provided to a consumer who provides the consumer's name and address to the user of the novel technology and to the product's supplier.

The system or method 100 provides a way to deter the submission of intentionally fraudulent customer contact information. For example, a consumer who selects a product does not benefit from providing a false name and address to the user of the novel technology or to the supplier that is supplying the product because the consumer will not receive the product if the offer for the product utilizes parcel service delivery to the consumer's home.

The system or method 100 provides a way to validate unique and real personal identities at the same address. For example, one embodiment of the novel technology may require only a consumer's address to function successfully. The method may institute a product availability limit in which a quantity of just one product is available to each unique address over a time period of 24 hours. In order to allow a plurality of individuals at the same address to participate, the method may allow a consumer to provide the consumer's name and the information for a valid credit card registered under the consumer's name in order to establish a unique identity for the consumer. The method may then use the consumer's name, address, and valid credit card to create the unique identity for the consumer. If the consumer were to attempt to defraud the method, such as by creating another account with the same name and address but with a different valid credit card, an algorithm may be used to recognize that the consumer already has an established identity and prevent the consumer from creating a second account. The algorithm could be used to prevent other attempts at defrauding the method by using a consumer's name, address, and valid credit card information.

The system or method 100 provides a way to measure, interpret, and compare the effectiveness of marketing strategies between products. For example, the method may display a particular product from a supplier who recently launched a variety of marketing campaigns in different geographic locations. The user of the method could compile and share the geographic selection data for the product with the supplier so that it could be cross-referenced with the geographic assignments of the marketing campaigns as a means to evaluate the effectiveness of each marketing campaign.

The system or method 100 provides a way to measure, interpret, and compare the customer conversion potential between products. For example, the method may display 10,000 different products supplied by 2,000 different suppliers across 20 different product industries. The user of the method could compile and share the geographic selection data for each product with each supplier so that purchase quantities could be compared against the selection quantities for a given product in a given geographic location.

The system or method 100 provides a way to improve the reputation of a product brand. For example, a supplier of a product may recognize how an embodiment of the novel technology leverages choice-supportive cognitive bias by instilling a sense of commitment into a consumer who selects the product. Perhaps the supplier recognizes how the embodiment leverages halo-effect cognitive bias when a consumer interprets a free product as a gesture of generosity. Perhaps the supplier recognizes how the embodiment leverages the reciprocity element of persuasion by instilling a sense of obligation into a consumer who selects the product to purchase the product from a retailer after receiving a free sample. The supplier may appreciate that these intended effects of the embodiment can be used to improve the reputation of its brand.

The system or method 100 provides a way to amplify the presence of a product brand. For example, an embodiment of the novel technology could use a website to display the products that are being offered.

Each product listing could contain a link to the website of the supplier of the product. The website of the supplier could contain a link to the website of the embodiment. Additionally, the social media accounts of the embodiment and suppliers could be linked. The network of links between the embodiment and the suppliers could improve the value and legitimacy scores that are calculated for the websites that are linked together.

The system or method 100 provides a way to distribute goods at a reduced cost and improved convenience. For example, an embodiment of the novel technology may involve the participation of a plurality of suppliers that deliver a high quantity of products each day in support of the embodiment. Some of the suppliers may be in direct or indirect competition with one another. The suppliers and the user of the embodiment could use the high quantity of deliveries as part of an agreement with a parcel service to reduce the cost to ship each product in support of the embodiment or offer special pick-up locations for some of the products in support of the embodiment. Despite potentially being in competition with one another, the suppliers have a common connection through the embodiment and each supplier could benefit from a reduced shipping cost or improved convenience obtained by approaching the parcel service as a single entity, in the form of the embodiment, which requires many deliveries.

The system or method 100 provides a way to reduce the cost of providing a product to a customer at no direct cost to the customer. For example, an embodiment of the novel technology could allow, encourage, facilitate, or in some other way condone the cooperation of a brand and a retailer in which the brand and the retailer share the costs of participating in the embodiment. Perhaps the brand recently released a new product to market and the retailer has been granted the exclusive right to sell the product. The retailer and the brand may both benefit from the product advertising opportunities that the embodiment offers. Therefore, both parties may agree to share the cost of delivering the product in support of the embodiment.

The system or method 100 provides a way for market associates to agreeably share product interest data. For example, Brand A and Brand B may offer similar products and may have formed a partnership in the same market space. Brand A and Brand B may form a mutually beneficial agreement where Brand A participates in an embodiment of the novel technology by offering Product A, which is very similar to a product offered by Brand B, and Brand B participates in the embodiment by offering Product B, which is very similar to a product offered by Brand A. Then, Brand A and Brand B could share the data collected on Product A and Product B with one another so that they both need to only pay the costs associated with offering one product while utilizing the data collected on both products. Another example is where an embodiment of the novel technology is arranged such that all suppliers agreeably participate in the embodiment knowing that each supplier is able to purchase data on any product offered through the embodiment. Perhaps the user of the embodiment sells the data collected on a product to a supplier that does not supply the product.

The system or method 100 is a method that delivers goods from suppliers to customers at no direct monetary cost to the customer in a way that is intended to be profitable to the supplier, the customer, and the user of the novel technology.

The described embodiments and drawings are to be considered in all respects only as illustrative and not restrictive. While specific examples have been described, it is understood that the novel technology can take many forms and extend across a wide variety of applications. The claims listed below indicate the scope of the novel technology.

1. A method in which a good is offered to a customer at no direct monetary cost to the customer, comprising a computer system, wherein the computer system comprises an information processor, software, and a network server, and wherein the method comprises the steps of:
a. determining the terms of an offer for a good;
b. creating an advertisement to present the offer to a potential customer;
c. displaying the advertisement through a network server for the potential customer to view;
d. receiving an acceptance of the offer for the good;
e. determining the compliance of the terms of the offer;
f. informing the customer that accepted the offer that the acceptance was processed;
g. informing the supplier of the good of the acceptance corresponding to the offer; and
h. providing the good to the customer that accepted the offer.

2. The method of claim 1, wherein the good is provided to the customer by delivering the good to the customer.

3. The method of claim 2, wherein the good is delivered using a parcel service.

4. The method of claim 1, wherein a voucher for the good is provided to the customer.

5. The method of claim 4, wherein the voucher is provided using an electronic mail service.

6. The method of claim 1, wherein the offer is displayed using computer software.

7. The method of claim 1, wherein the offer is displayed on an Internet website.

8. The method of claim 1, wherein the offer is displayed on a mobile device.

9. The method of claim 1, wherein there is a direct non-monetary cost to the customer.

10. The method of claim 1, wherein there is an indirect cost to the customer.

11. The method of claim 10, wherein the indirect cost is monetary.

12. The method of claim 1a, wherein the terms of the offer comprise a constraint on the quantity of the good that is offered.

13. The method of claim 1a, wherein the terms of the offer comprise a constraint on the time that the good is offered.

14. The method of claim 13, wherein the time is a duration.

15. The method of claim 1a, wherein the terms of the offer comprise a constraint on the geographic location where the good is offered.

16. The method of claim 15, wherein the constraint is defined using postal codes.

17. The method of claim 1a, wherein the terms of the offer comprise a constraint on the eligibility of the potential customer to accept the offer.

18. The method of claim 1, further comprising obtaining consent from the supplier to advertise the good to the potential customer.

19. The method of claim 1, further comprising collecting feedback from the customer.

20. The method of claim 18, wherein the feedback references the good.

21. The method of claim 18, further comprising sharing the feedback with another party.

22. The method of claim 1, further comprising allowing the customer to display the acceptance to another potential customer for purchase or trade.

23. The method of claim 22, further comprising providing for the customer displaying the acceptance to communicate with another potential customer desiring to purchase or trade for the acceptance.

24. The method of claim 23, further comprising allowing the customer to transfer ownership of the acceptance to another potential customer.

25. The method of claim 1, further comprising obtaining information about the potential customer.

26. The method of claim 25, further comprising matching the potential customer to a particular offer based on the information obtained about the potential customer.

27. The method of claim 25, further comprising sharing the information with another party.

28. The method of claim 1, further comprising rewarding the customers.
